(19) United States
(12) Patent Application Publication
(10) Pub. No.: US 2008/0270739 A1
(43) Pub. Date: Oct. 30, 2008

(54) Management of copy-on-write fault

(76) Inventors: Eric W. Hamilton, Mountain View, CA (US); Vishwas Pandian Durai, Santa Clara, CA (US); Srisallendra Yallapragada, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,512

(22) Filed: Apr. 27, 2007

(51) Int. Cl. G06F 12/08

(52) U.S. Cl. 711/206

(57) ABSTRACT

An embodiment of the invention provides an apparatus and method for management of copy-on-write faults. The apparatus and method include the acts of: assigning a translation to a first physical memory page, where the translation is a virtual memory address to physical memory address translation and where an offset portion in the translation includes a physical address of the first physical memory page; and creating a second physical memory page which is a copy of the first physical memory page.

### TECHNICAL FIELD

Embodiments of the invention relate generally to management of a copy-on-write (CoW) fault.

### BACKGROUND

Many commercially available operating systems (OS) use copy-on-write as a method to achieve optimization in operations. Copy-on-Write (CoW) is used in a fork operation, where the operating system (OS) creates a replica of a process (i.e., a running instance of an application). The original process requesting the fork( ) operation is the parent process and the newly created process is the child process. The child process expects to have a copy of the contents of parent's address space at the time of fork. As known to those skilled in the art, the copy-on-write in a fork( ) operation applies only to a process' private memory pages. Copy-on-write is an optimization that causes physical memory pages of the parent process to be shared with the child process for memory read operations. These shared pages are marked by the OS as copy-on-write. A page that is marked copy-on-write will remain as a shared page to the parent process and child process even if both processes perform a read operation on the shared page. In an alternative implementation in, for example, the HP-UX operating system, a shared page will be marked as copy-on-write for the parent process and copy-on-access for the child process.

However, when either the parent process or the child process writes to a shared page that is marked copy-on-write, a page fault exception (i.e., copy-on-write fault) occurs, where the process that is performing the write operation is given a copy of the page to be written. Copying of metadata of the shared page will occur at the time of the fork( ) operation. At the time of CoW fault, actual data are copied from the shared page. After a process writes to that copied page, that page will remain visible to that process but will not be visible to other processes until there is another instance of an event such as a fork( ) system call and the new page as marked as copy-on-write once again. The use of copy-on-write permits a very efficient fork operation because copying all pages of the parent process onto the address space of the child process is avoided by use of the shared pages.

A Translation Lookaside Buffer (TLB) is a cache in a processor and is used to improve the speed of translations of virtual addresses to physical addresses. A TLB contains a list that translates the virtual addresses into physical addresses for the pages. When a page is copied, a temporary translation kernel virtual address is required to be used and to be pointed to the source page that will be copied. A temporary kernel translation is used for the source page only. This is always needed when the parent process is the process that takes the CoW fault. When the parent process writes to the CoW page, the existing read-only translation to the source page will need to be removed since the parent process is to be pointed to the new page. Therefore, a new kernel translation for the source page is needed to make the copy to the new page. When the child process takes the CoW fault, the source page may have the parent process's read-only translation. In that case, this read-only translation is used for the source page and there is no need to create a new kernel translation. But if parent process's translation to the source page does not exist for some reason, then a new kernel translation for the source page will need to be created. After the page is copied, a global purge of this temporary translation kernel virtual address is required to be performed. A hardware walker will place this temporary address in all TLBs in other processors. This global purge will remove this temporary translation kernel virtual address from all TLBs in the system, since this temporary address is now a stale translation that can cause data corruption. However, this global purge requires the processors to contend for a global spinlock. A global spinlock for the global TLB purge is required on the Intel Itanium Platform Family (IPF) architecture. On a machine with many processors, this spinlock contention can reduce the application performance speed.

A local purge of the temporary translation kernel virtual address may instead be performed, where the temporary address is removed from only the TLB of the processor that is involved in the fork operation. However, a local purge would not purge this temporary address that may have been stored in other TLBs in other processors. The use of this temporary address in a subsequent fork operation can cause data corruption.

Therefore, the current technology is limited in its capabilities and suffers from at least the above constraints and deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) that can use an embodiment of the invention.

FIGS. 2A-2E are block diagrams that illustrate the management of a copy-on-write fault, in accordance with an embodiment of the invention.

FIG. 3 is a flow diagram of a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

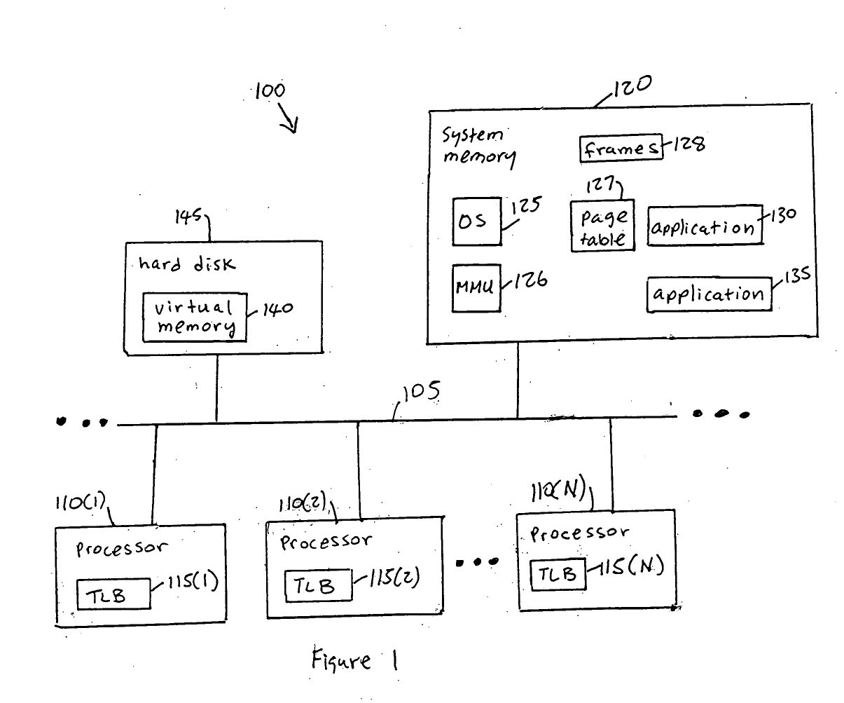

FIG. 1 is a block diagram of an apparatus (system) 100 that can use an embodiment of the invention. The system 100 is typically implemented in a computing device. Various components in the system 100 are connected to a system bus 105. The system 100 includes the processors 110(1), 110(2) to 110(N), where N is a suitable positive integer value based on the scalability of the system 100. The number of processors (generally referred to as processors 110) in the system 100 may vary. Each processor 110 has a translation lookaside buffer (generally referred to as TLB 115) which contains a list that translates the virtual memory addresses in virtual memory 140 into physical memory addresses for the physical memory pages in the system memory 120. These physical memory pages are memory spaces in physical frames 128 in the system memory 120. The processors 110 can execute the software elements in the system memory 120, such as, for example, an operating system (OS) 125 and applications 130 and 135. The OS 125 maintains page tables 127 that indicate the physical memory pages that are allocated to processes of applications and also indicate if the physical memory pages are set to copy-on-write. The number of software elements in the system memory 120 may vary.

The OS 125, memory management unit 126, and processors 110 can provide a standard virtual memory subsystem, where memory space (virtual memory) 140 on a hard disk 145 is swapped with memory space (e.g., RAM) in the system memory 120 to provide increased memory storage for applications.

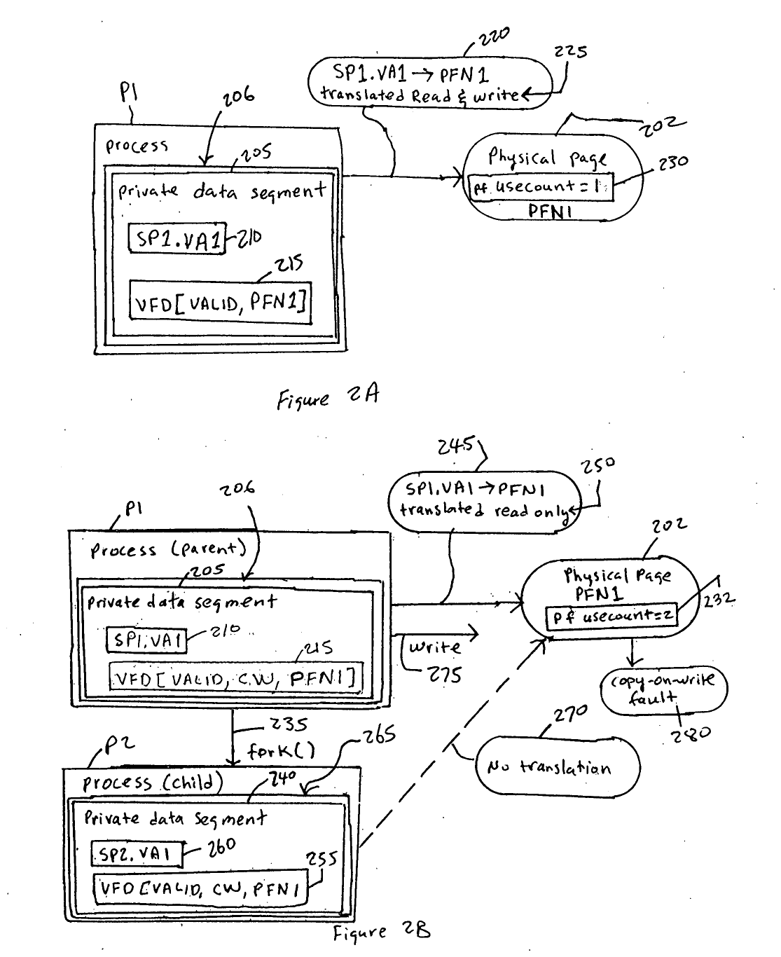

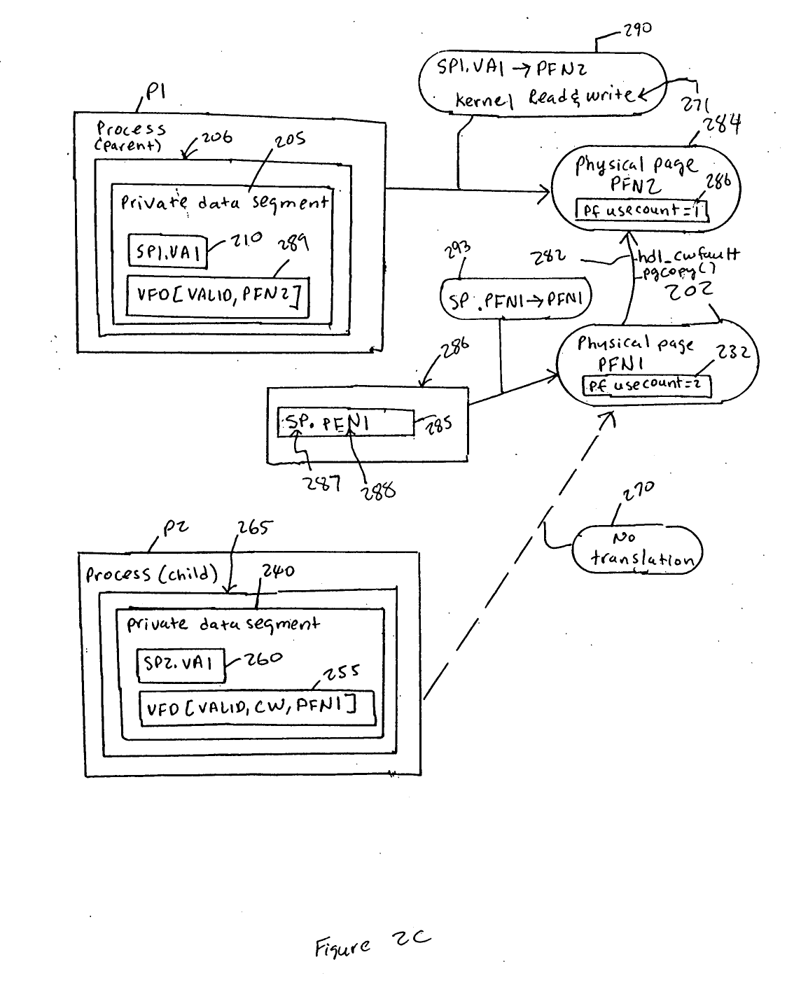

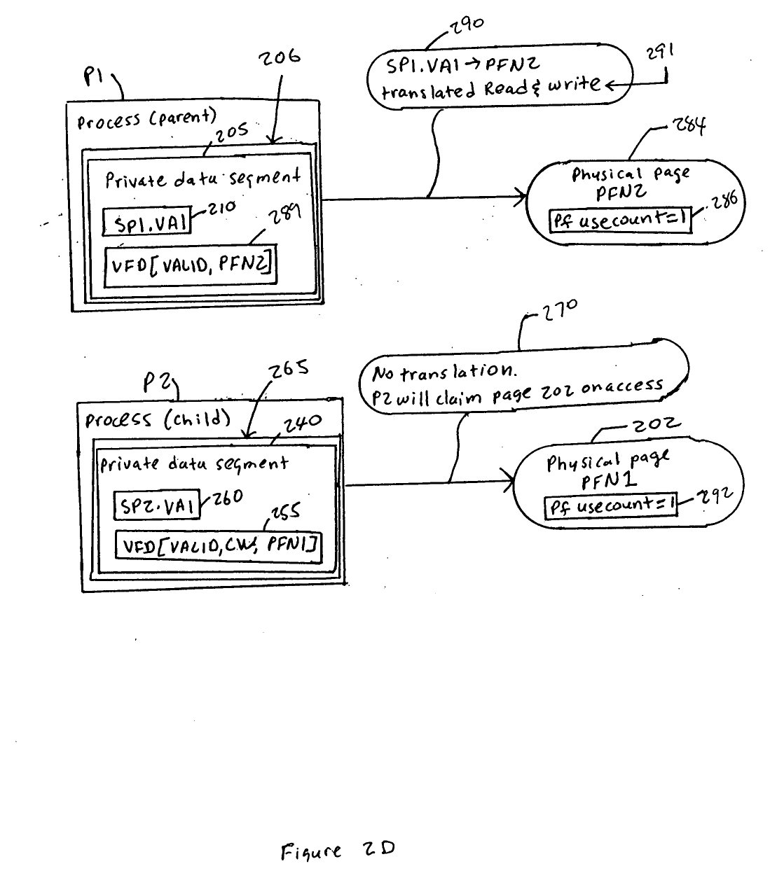

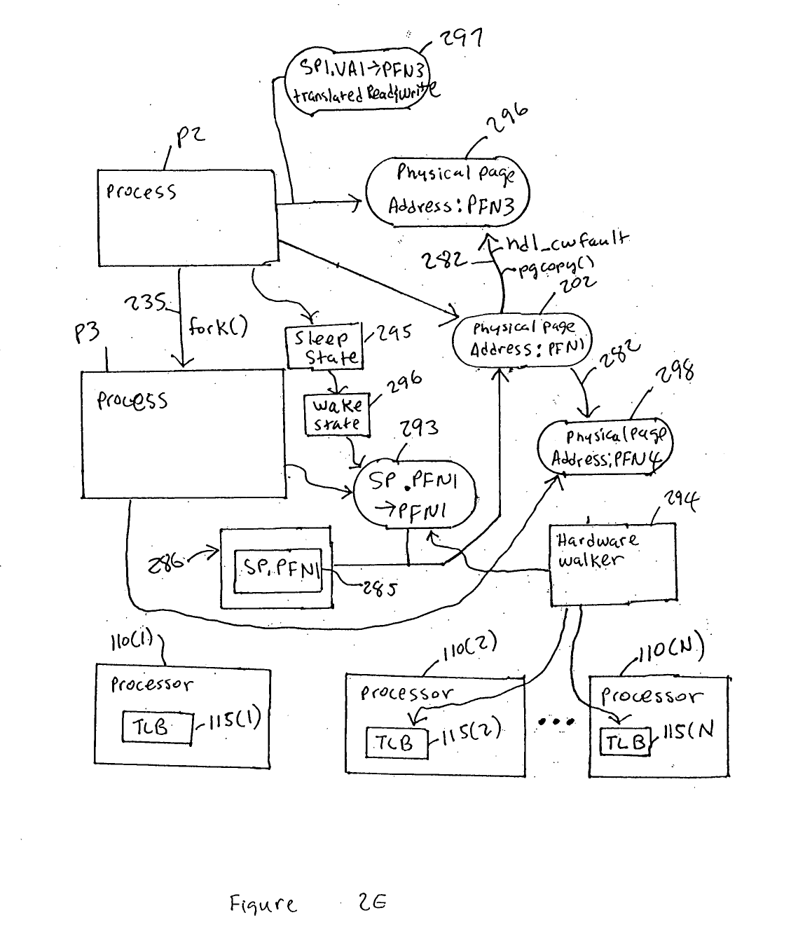

FIGS. 2A-2E are block diagrams that illustrate the management of a copy-on-write fault, in accordance with an embodiment of the invention. The steps in FIGS. 2A-2E illustrate a method for advantageously eliminating the need to perform global purges in the translation lookaside buffers 115 (FIG. 1) when a copy-on-write (COW) fault occurs. The steps in FIGS. 2A-2E are typically permitted by a CoW code path that is implemented in the operating system 125 (FIG. 1) and are performed by use of storage spaces in the system 100. As known to those skilled in the art, a CoW fault occurs when a parent process attempts to write to a physical memory page whose translation is set as a read-only translation after the parent process has executed a fork( ) system call to create a child process. An example of an operating system that supports the fork( ) system call is the HP-UX operating system which is commercially available from HEWLETT-PACKARD company.

In FIG. 2A, a process P1 has a virtual memory page 206 that is allocated for its private data segment 205. This virtual memory page 206 has the virtual memory address SP1.VA1 in a virtual memory (e.g., virtual memory 140 in FIG. 1). This virtual memory page 206 is mapped to (points to) a physical memory page 202 (having a physical memory address PFN1) in the system memory 120, in accordance with standard virtual-to-physical memory mapping techniques that are performed by a virtual memory system. The process P1 is, for example, a running instance of an application (e.g., application 130 in FIG. 1). The private data segment 205 can be, for example, any metadata structure of the process P1. For example, the private data segment 205 is a component of the application context of process P1. As known to those skilled in the art, an application context includes at least an application code and an address (virtual memory point). The physical page 202 is typically a memory area in the system memory 120 (FIG. 1).

The process P1 has a private data segment 205 which is mapped to a virtual memory page 206 by the space/offset tuple 210 which includes the space identifier (space ID) “SP1” and offset “VA1”. A tuple can have other space ID and offset names, depending on the virtual memory address that is identified by the tuple. The tuple 210 maps the private data segment 205 to the virtual memory page 206 with the virtual memory address, SP1.VA1. In actual implementations, the virtual memory addresses (e.g., SP1.VA1) and physical memory addresses (e.g., PFN1) are typically bit values. However, for purposes of clarity in the discussions below, these addresses are referred herein by use of particular example names (e.g., SP1.VA1 and PFN1).

The private data segment 205 has a descriptor 215 which will map the virtual memory page 206 (containing the segment 205) to the physical memory page 202. The tuples (e.g., tuple 210) and descriptors (e.g., descriptor 215) are typically stored as metadata in the system memory 120. Typically, the descriptor 215 is a virtual frame descriptor VFD. As known to those skilled in the art, a VFD can be set with a VALID flag which indicates that data (e.g., private data segment 205), that is mapped to a virtual memory page, is currently in the system memory 120 (FIG. 1). A VFD also includes a PFN number (e.g., PFN1 in descriptor 215) which indicates the physical memory page (e.g., physical page 202) and physical memory address (PFN1) that will store the data (e.g., segment 205) of the virtual memory page 206. It is also noted that a copy-on-write flag (flag CW in FIGS. 2B and 2D) are not set in the descriptor 215. This means that the physical page 202 at address PFN1 is not set to copy-on-write. Therefore, when the process P1 performs a write access to the physical page 202, a copy-on-write fault (an access rights fault) will not occur.

A translation 220 maps the virtual memory page 206 (as well as the segment 205) at virtual memory address SP1.VA1 to the physical memory page 202 at physical memory address PFN1. The translations that are shown in FIGS. 2A-2E are stored in the TLBs 115 in FIG. 1. The translation 220 indicates that the virtual memory address SP1.VA1 points to (maps to) the physical memory address PFN1 of the physical page 202. The translation 220 includes the access rights attributes 225 which indicate the access rights of process P1 to the physical page 202. In the example of FIG. 2A, the access rights attributes 225 indicates “translated read and write” which means that the process P1 is permitted to read from and write to the physical page 202 without generating an access rights fault (e.g., copy-on-write fault).

The physical page 202 is memory space in the system memory 120. The physical page 202 has a page frame use count (pf usecount) 230 which indicates the number of processes that can access the physical page 202. In FIG. 2A, since the process P1 is the only process that can access the physical page 202, the use count 230 is set to “1”.

In FIG. 2B, the process P1 sends a fork( ) system call 235 in the OS 125 (FIG. 1) which results in the creation of a process P2 which is a copy of process P1. As known to those skilled in the art, after a fork( ) system call 235, the calling process P1 will be a parent process and the newly-created process P2 will be a child process. The private data segment 205 of the parent process P1 is copied and allocated as the private data segment 240 of the child process P2. This copying and allocation of private data segment involves copying of metadata structures of process P1 into process P2.

After the fork( ) system call 235, for process P1, the VALID flag in the VFD descriptor remains set for the private data segment 205 in parent process P1. Therefore, this VALID flag means that the private data segment 205 in the virtual memory page 206 is currently in the system memory 120 (FIG. 1). The CW flag is also set in the VFD descriptor 215 to indicate that the physical page 202 has been set to copy-on-write.

After the fork( ) system call 235, a translation 245 still maps the virtual memory page 206 (at virtual memory address SP1.VA1) to the physical memory 202 (at physical memory address PFN1) as shown by SP1.VA1-PFN1. The access rights attributes 250 indicates “translated read only” which means that the process P1 can only read from the physical page 202, and a write attempt by process P1 to the page 202 will generate a copy-on-write fault. Note also that the VFD descriptor 215 now has the CW flag set, which indicates that physical page 202 has been set to copy-on-write.

Also, after the fork( ) system call 235, the usecount 232 for physical page 202 is set (incremented) to “2” because the parent process P1 and child process P2 can now access the physical page 202.

The child process P2 has the same bits (VALID, CW, PFN1) set in the VFD descriptor 255 for the private data segment 240 in virtual memory page 265. The tuple 260 indicates that the private data segment 240 is allocated to a different virtual memory page 265 at virtual memory address SP2.VA1, where “SP2” is the space ID and “VA1” is the same VA1 offset for the private data segment 205 of process P1. The VFD descriptor 255 points the virtual memory page 265 to the physical page 202 because of the PFN1 value in the VFD descriptor 255. However, the child process P2 does not have a translation (as symbolized by the no translation block 270) for mapping the virtual memory address SP2.VA1 to the physical address PFN1 because the child process P2 has not yet attempted to access the physical page 202. The translation for mapping the virtual memory address to physical address is not created until a process actually requests an access a physical memory page.

As discussed above, physical page 202 is currently set to copy-on-write (CoW) after the fork( ) system call 235 is completed. The above-discussed virtual memory subsystem currently uses CoW for the parent process P1. Therefore, if the parent process P1 attempts a write access 275 to the physical page 202, CoW will be “broken” for page 202, and parent process P1 will obtain a copy of the original page 202. Assume that the parent process P1 attempts to write 275 to the physical page 202 that is mapped by the virtual memory address SP1.V1. Since the physical page 202 has a READ only translation 245, a data access rights violation (copy-on-write fault) will occur in response to the write access attempt by the parent process P1. The copy-on-write fault is represented by block 280 for convenience. This copy-on-write fault 280 is detected by a CoW code path that is implemented in a hdl_cwfault routine in the OS 120. As shown in FIG. 2C, the hdl_cwfault routine determines when a physical page is to be copied and the pgcopy( ) routine performs the copying of the page to create a new physical page 284 that will be allocated to the process P1 that caused the CoW fault 280.

FIG. 2C is a block diagram that illustrates the management of a copy-on-write fault, as performed by an embodiment of the invention. When the copy-on-write fault occurs, in operations 282 the hdl_cwfault routine detects the fault occurrence and also determines that physical page 202 at address PFN1 needs to be copied, and the hdl_cwfault( ) routine allocates the physical page 284. The pgcopy( ) routine copies the data from page 202 to page 284. The physical page 284 has a physical memory address at PFN2 and has a pf usecount 286 of “1” because only the process P1 is permitted access to the physical page 284.

An embodiment of the invention advantageously eliminates the need to perform a purge of stale temporary translations that may be in all TLBs 115 in the system 100 (FIG. 1), by creating a space/offset tuple that does not need to be globally purged in all of the TLBs. In order to create the SP1.VA1->PFN2 translation (block 290), a deletion is performed on the SP1.VA1->PFN1 read-only translation (block 245). This deletion will result in a global purge. An embodiment of the invention optimizes the removal of the new, temporary translation that is created for use by pgcopy( ) to perform the data copy. This space/offset tuple (e.g., tuple 285 or virtual memory address portion 285) is an address to a virtual memory page (e.g., virtual memory page 286). The space/offset tuple 285 has a global space ID component 287 which is a system wide global identifier that is known to all processes in the system and an offset 288 which is the physical memory address value of the source physical memory page (page to be copied), as discussed further below. In the example of FIG. 2C, the global space ID 287 is “SP” and the offset component 288 is PFN1 which is also the physical memory address PFN1 of the source physical page 202 to be copied. The use of this space/offset tuple 285 is discussed further below in FIG. 2E.

In FIG. 2C, the OS 125 then creates the translation 290 (SP1.VA1-PFN2) to map the virtual memory address SP1.VA1 to the physical memory address PFN2. This copied page 284 is given kernel-only Read/Write access rights 271 to prevent other threads in process P1 from using this translation 290 before the copy operation has been completed for new page 284. In other words, the process P1 will stall while the copy operation has not yet completed.

The pgcopy( ) routine will then copy the contents of PFN1 over to PFN2. In previous methods, a temporary translation maps a temporary virtual address (e.g., KERNELSPACE.KVADDR) to PFN1 and this temporary translation is then globally purged to remove this temporary translation from all TLBs in all processors. This temporary translation requires the purging from all TLBs because this translation can map the same virtual address KERNELSPACE.KVADDR to multiple physical pages if additional pgcopy( ) routines are subsequently performed. Therefore, this temporary translation can map the same virtual address to different physical pages, among the different TLBs, and can result in the staleness problem that was previously discussed above. As also discussed above, this global purge results in a spinlock contention that can reduce the speed of application performance. As discussed in detail below, the use of the space/offset tuple 285 advantageously eliminates the need to perform this global purge when copy-on-write has been completed.

When copy-on-write has been completed, the SP1.VA1 tuple 210 gives the process P1 its original read and write access rights, as shown by the attributes 291 in FIG. 2D. In FIG. 2D, after the copy-on-write has been completed, since the new physical page 284 at physical memory address PFN2 is allocated to the parent process P1, the VFD descriptor 289 will have the VALID flag set and the physical memory address PFN2 value. The CW flag is not set in the VFD descriptor 289 to indicate that the physical page 284 is not set to copy-on-write.

In FIG. 2D, the translation 290 maps the virtual memory page 206 (at virtual memory address SP1.VA1) to the physical memory 284 (at physical memory address PFN2) as shown by SP1.VA1-PFN2. The access rights attributes 291 indicates “translated read and write” which means that the process P1 can read from and write to the physical page 291 without generating an access violation.

In FIG. 2D, the child process P2 has the same bits (VALID, CW, PFN1) set in the VFD descriptor 255 for the private data segment 240 in virtual memory page 265. The tuple 260 indicates that the private data segment 240 is allocated to the virtual memory page 265 at virtual memory address SP2.VA1. The VFD descriptor 255 points the virtual memory page 265 to the physical page 202 because of the PFN1 value in the VFD descriptor 255. The child process P2 does not have a translation (as symbolized by the no translation block 270) for mapping the virtual memory address SP2.VA1 to the physical address PFN1 because the child process P2 has not yet attempted to access the physical page 202. However, the process P2 will claim the page 202 when the process P2 accesses the page 202. The usecount 292 is at value “1” because the process P2 is permitted to access the physical page 202.

Reference is made to FIG. 2E, for purposes of discussion of additional details of the space/offset tuple 285 that does not require to be purged in the TLBs 115. When the copy-on-write fault occurs, the operating system 125 will create the translation 293 which maps the virtual memory address SP.PFN1 to the physical memory address PFN1. The use of the tuple 285 avoids the previous requirement of using the temporary translation KERNELSPACE.KVADDR that requires the global purges in previous methods. As known to those skilled in the art, this temporary translation KERNELSPACE.KVADDR is required to be globally purged when copy-on-write has been completed because this translation can have different values (in the TLBs) that may map a virtual memory address to different physical memory addresses after copy-on-write is performed.

The space/offset tuple 285 provides a unique spaceID and offset that will always point to the physical address PFN1. Since a physical memory address is unique for each physical page, each tuple 285 will be unique because of the unique offset value.

As mentioned above, a standard hardware walker 294 (which is typically part of a processor hardware) can insert into the TLBs 115 the temporary translation of the physical page to be copied during copy-on-write. In FIG. 2E, as a first example, assume that the process P2 was being executed on the processor 110(1) during the copy-on-write that was discussed in FIG. 2C for physical page 202. The hardware walker 294 may insert the translation 293 in the TLBs 110(1), 110(2) to 110(N). Assume that the process P2 is placed in a sleep state 295 at any particular time between the step of creating the translation 293 and the completion of a copy-on-write that creates physical page 296 which is a copy of physical page 202. If the process P2 then wakes 296 (i.e., is to be executed) on a different processor 110 (e.g., processor 110(2)), the process P2 will use the translation 293 (SP1.FN1-PFN1) in buffer 115(2) as a translation for physical page 202 when completing the copy-on-write to create new physical page 296. Therefore, the process P2 uses the correct translation 293 to map to the physical page 202 for any processor 110 that executes the process P2, because the translation 293 is a unique translation that points to page 202. Note that a local purge need not be performed on the TLB 115(2) for the translation 293 because the translation 293 always points to the unique physical memory address PFN1. The process P2 will then point the new page 296 as shown by the translation 297

As another example, assume that process P3 is currently pointing to page 202 at address PFN1 and is running on processor 110(1), and assume further that a fork( ) system call 235 creates the new process P3 which is a child process of process P2. The process P3 would point to page 202. If the process P3 attempts to write to the physical page 202 that results in a CoW fault and the process P3 moves into a sleep state and wakes up on a different processor (e.g., processor 110(2)) during copy-on-write, then the process P2 can still use the translation 293 in the TLB 115(2) to correctly point to the source page 202, as similarly discussed above. After copy-on-write is completed, the process P3 will point to the new physical page 298 at address PFN4. Note that if physical page 298 will be subsequently copied for a copy-on-write, the temporary translation to be given to the page 298 will be SP.PFN4.

Therefore, a temporary translation (e.g., translation 293) contains a temporary virtual address (e.g., SP.PFN1) that uses the physical address (e.g., PFN1) of the mapped physical page. Since this temporary translation will always point to the correct physical page, this temporary translation is unique for each physical page. As a result, this temporary translation is not required to be globally purged from the TLBs 115. Therefore, an embodiment of the invention advantageously eliminates the global TLB purges that were required in the previous methods that used a temporary translation that was not unique to each physical page and as a result, was subject to staleness. By eliminating the global TLB purges, an embodiment of the invention permits an operating system is to become more scalable (i.e., more processors can be added to the system) and applications can notice a significant performance improvement.

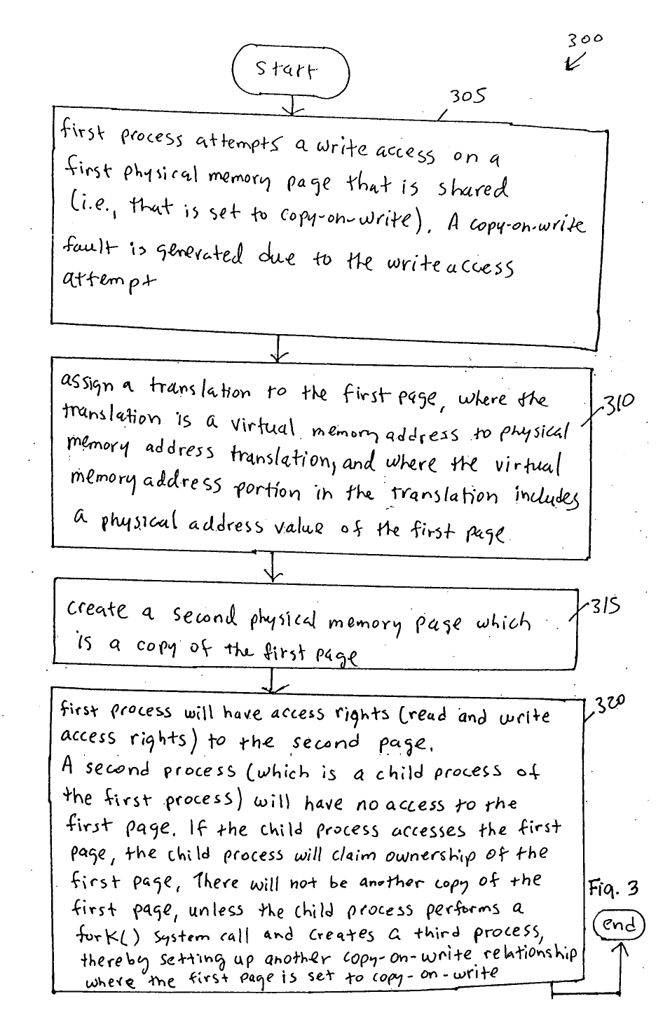

FIG. 3 is a flow diagram of a method 300 in accordance with an embodiment of the invention. In block 305, a first process attempts a write access to a first page (e.g., at physical memory address PFN1), where the first page is a shared page (i.e., is set to copy-on-write or CoW). As a result of the write access attempt, a CoW fault (access violation) is generated.

In block 310, a translation is assigned to the first page, where the translation is a virtual memory address to physical memory address translation, and where the offset portion in the translation includes a physical address value of the first page.

In block 315, a second physical memory page is created. The second physical memory page is a copy of the first page.

In block 320, when copy-on-write has been completed, the first process will have access rights (read and write access writes) to the second page. A second process, which is a child process of the first process (and which may be created by, e.g., a fork( ) system call), will not have read access rights to the first page at the end of breaking CoW for the parent process. The child process will have no access to the first page. If the child process accesses the first page, the child process will claim ownership of the first page. There will not be another copy of the first page, unless the child process performs a fork( ) and creates a third process, thereby setting up another CoW relationship where the first page is set to copy-on-write.

It is also within the scope of the present invention to implement a program or code that can be stored in a machine-readable or computer-readable medium to permit a computer to perform any of the inventive techniques described above, or a program or code that can be stored in an article of manufacture that includes a computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for management of a copy-on-write fault, the method comprising:
assigning a translation to a first physical memory page, where the translation is a virtual memory address to physical memory address translation and where an offset portion in the translation includes a physical address of the first physical memory page; and
creating a second physical memory page which is a copy of the first physical memory page.

2. The method of claim 1, further comprising:
prior to assigning the translation, attempting a write access by a first process to the first physical memory page that is set to copy-on-write.

3. The method of claim 2, wherein the first process has read and write access rights to the second page.

4. The method of claim 2, further comprising:
creating a second process which is a child process of the first process.

5. The method of claim 4, wherein the second process will not have access to the first page after copy-on-write is completed for the first process, and wherein the second process is required to attempt access to the first page to create a translation for that first page.

6. The method of claim 1, further comprising:
storing the translation in buffers in processors.

7. The method of claim 6, further comprising:
executing the first process on a first processor;
placing the first process in a sleep state, after the translation has been stored in the buffers; and
executing the first process in a second processor, where the first process uses the translation to reference the first page.

8. The method of claim 6, further comprising:
creating a second process;
executing the second process on the first processor;
placing the second process in a sleep state, after the translation has been stored in the buffers; and
executing the second process in a second processor, where the second process uses the translation to reference the first page.

9. The method of claim 1, wherein a particular physical page is associated with a particular translation and wherein the particular translation includes a physical address value of the particular physical page.

10. The method of claim 1, wherein the translation does not require deletion in a buffer after a copy-on-write has been completed.

11. An apparatus for management of a copy-on-write fault, the apparatus comprising:
an operating system configured to assign a translation to a first physical memory page that is set to copy-on-write, where the translation is a virtual memory address to physical memory address translation and where an offset portion in the translation includes a physical address of the first physical memory page, and configured to create a second physical memory page which is a copy of the first physical memory page.

12. The apparatus of claim 11, wherein a first process attempts a write access to the first physical memory page that is set to copy-on-write.

13. The apparatus of claim 12, wherein the first process has read and write access rights to the second page.

14. The apparatus of claim 12, wherein a second process is created and wherein the second process is a child process of the first process.

15. The apparatus of claim 14, wherein the second process will have no access to the first page after copy-on-write is completed for the parent process, and wherein the child process is required to attempt access to the first page to create a translation for that first page.

16. The apparatus of claim 11, wherein the translation is stored in buffers in processors.

17. The apparatus of claim 16, wherein the first process executes on a first processor, wherein the first process is placed in a sleep state, after the translation has been stored in the buffers, and wherein the first process executes in a second processor, where the first process uses the translation to reference the first page.

18. The apparatus of claim 16, wherein a second process is created, wherein the second process executes on the first processor, wherein the second process is placed in a sleep state, after the translation has been stored in the buffers, and wherein the second process executes in a second processor, where the second process uses the translation to reference the first page.

19. The apparatus of claim 11, wherein a particular physical page is associated with a particular translation and wherein the particular translation includes a physical address value of the particular physical page.

20. The apparatus of claim 11, wherein the translation does not require deletion in a buffer after a copy-on-write has been completed.

21. An apparatus for management of a copy-on-write fault, the apparatus comprising:
means for assigning a translation to a first physical memory page, where the translation is a virtual memory address to physical memory address translation and where an offset portion in the translation includes a physical address of the first physical memory page; and
means for creating a second physical memory page which is a copy of the first physical memory page.

22. An article of manufacture comprising:
a machine-readable medium having stored thereon instructions to:
assign a translation to a first physical memory page, where the translation is a virtual memory address to physical memory address translation and where an offset portion in the translation includes a physical address of the first physical memory page; and
create a second physical memory page which is a copy of the first physical memory page.
